(19) United States
(12) Patent Application Publication
(10) Pub. No.: US 2007/0036055 A1
(43) Pub. Date: Feb. 15, 2007

(54) Device, method and program for recovering from media error in disk array device

(75) Inventor: Mikio Ito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/289,426

(22) Filed: Nov. 30, 2005

(30) Foreign Application Priority Data
Aug. 15, 2005 (JP) 2005-235565

(51) Int. Cl. G11B 20/18

(52) U.S. Cl. 369/53.35; 369/53.42

(57) ABSTRACT

In order to provide a device, a method and a program for recovering from a media error even when the media error occurs in a disk array apparatus in a state such that the disk array device lacks redundancy, a disk array control device 100 is provided with at least a media error information storage process unit 101 for detecting a media error and for registering a storage area in which the media error has occurred in a media error management table 102, the media error management table 102, a media error avoidance process unit 103 for issuing a write request after causing the disk device group 104 to conduct a reassignment process when a write request is to be made to the storage area in which the media error has occurred.

### BACKGROUND OF THE INVENTION

1. Field of the Invention

The present invention relates to a device, a method and a program for recovering from a media error occurring in a disk array device in a state where the disk array device lacks redundancy.

2. Description of the Related Art

In recent years, in order to avoid a loss of data due to a failure or the like of a disk device, or to improve process performance, a disk array device is widely employed in which a plurality of disk devices (for example, hard disk devices) are combined.

Many disk array devices have redundancy, thus, even when an inevitable fault occurs in one of the disk devices constituting a disk array device, data which has become unreadable due to the failure can be restored from the other disk devices. A representative example thereof is RAID (Redundant Arrays of Inexpensive/Independent Disks) which includes RAID1, RAID5 and the like.

However, there has been a problem that a disk array device which employs a configuration that inherently lacks redundancy such as RAID0 for example, or a disk array device that is in a state without redundancy because it has already degenerated due to a failure or the like, can not easily recover from a media error due to an inevitable fault as described above.

Japanese Patent Application Publication No. 60-086622 discloses an input and output control device for a disk device in which when a write error is detected, the invalidity of the erroneous record is registered in a management table, and data is written in a fungible record.

Japanese Patent Application Publication No. 10-050005 discloses a method of management for failure in an optical disk, where data is secured by conducting an fungible process based on data which is successfully read by a retry process for a defective sector in which a read retry process is conducted.

Japanese Patent Application Publication No. 2004-062376 discloses a processing method for read error in a RAID disk in which it is indicated whether or not data with an address for which a read error is detected in an input disk, which is used for recovery during a rebuild process, is a valid file after the restoration.

However, none of the above techniques solve a problem that when a media error occurs in a disk array device in a state without redundancy, a recovery process cannot be done easily.

### SUMMARY OF THE INVENTION

In view of the above problems, it is an object of the present invention to provide a device, a method and a program for recovering from a media error in a disk array device whereby recovery can be easily done even when a media error occurs in the disk array device in a state such that the disk array device lacks redundancy.

In order to solve the above problems, a disk array control device according to the present invention comprises a media error information storage process unit for detecting a media error occurring in a disk device group based on a response to a read request made to the disk device group including a combination of a plurality of disk devices, and for storing a storage area in which the media error occurred in a media error management table, and a media error avoidance process unit for causing, when a write request to a storage area stored in the media error management table is to be issued, the disk device group to conduct a reassignment process of assigning the storage area to another storage area, and thereafter, issuing the write request.

According to the present invention, the media error information storage process unit detects a storage area in which the media error has occurred in a disk device group, and stores the storage area in the media error management table. The media error avoidance process unit checks whether or not a write request is to be made to the storage area stored in the media error management table upon the write request to the disk device group. When the write request is to be made to the corresponding storage area, a reassignment process is conducted on the disk device group and thereafter the write request is made.

Thereby, it is possible to avoid writing data to a storage area in which a media error has occurred in the disk device group. In other words, it is possible to recover easily even when a media error occurs in a disk array device.

Also, the present invention can be realized by a program for recovering from a media error occurring in a disk device group in which a disk array control device is caused to conduct a media error information storage process of detecting a media error which occurred in a disk device group based on a response to a read request made to the disk device group including a combination of a plurality of disk devices, and storing a storage area in which the media error occurred in a media error management table, and a media error avoidance process of causing, when a write request to the storage area stored in the media error management table is to be made, the disk devices group to conduct a reassign process of assigning the storage area to another storage area, and thereafter, making the write request.

Also, the present invention can be realized by a disk array device, comprising a disk device group including a combination of a plurality of disk devices, which has a function of conducting a reassign process of assigning a storage area with a defect to another area, a media error information storage process unit for detecting a media error which occurred in a disk device group based on a response to a read request made to the disk device group, and for storing a storage area in which the media error occurred in a media error management table, and a media error avoidance process unit for causing, when a write request in the storage area stored in the media error management table is to be made, the disk device group to conduct a reassignment process of the storage area, and thereafter, make the write request.

As above, according to the present invention, it is possible to provide a device, a method and a program for recovering from a media error in a disk array device that can easily recover even when a media error occurs in a disk array device in a state without redundancy.

### BRIEF DESCRIPTION OF THE DRAWINGS

FIG. 1 shows a principle of the present invention;

FIG. 2 explains a configuration of a disk array control device according to the present invention;

FIG. 3 explains a media error information storage process according to the present invention;

FIG. 4 shows an example of a media error management table at the time of a media error information storage process according to the present invention;

FIG. 5 is a flowchart for a process to register information in the media error management table according to the present invention;

FIG. 6 explains a media error avoidance process according to the present invention;

FIG. 7 shows an example of a media error management table at the time of the media error avoidance process according to the present invention; and

FIG. 8 is a flowchart for the media error avoidance process according to the present invention.

### DESCRIPTION OF THE PREFERRED EMBODIMENT

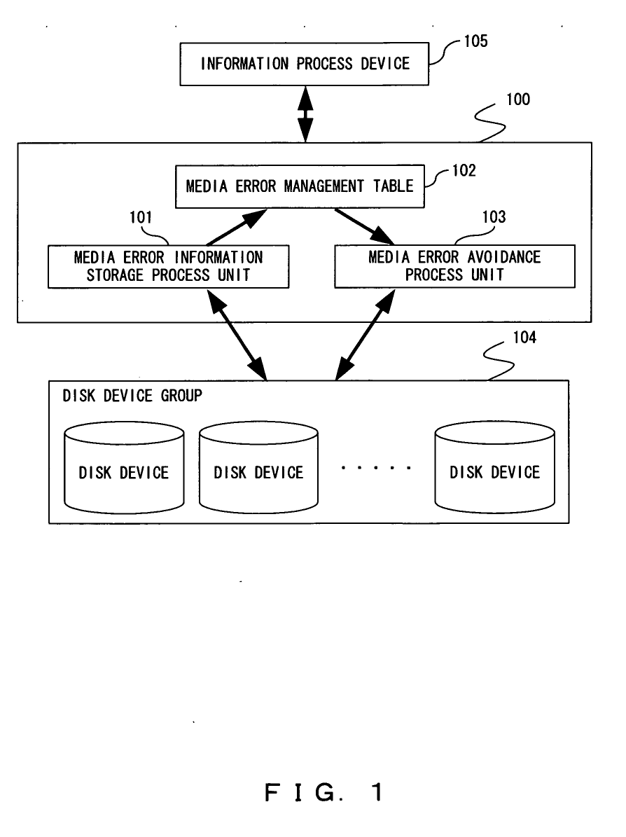

Embodiments of the present invention will be explained by referring to FIG. 1 to FIG. 8.

FIG. 1 shows a principle of the present invention.

A disk array control device 100 shown in FIG. 1 comprises, at least, a media error information storage process unit 101 for detecting a media error occurring in a disk device group 104 and for registering a storage area in which the media error has occurred in a media error management table 102, the media error management table 102 in which the storage area in which the media error has occurred is registered, a media error avoidance process unit 103 for issuing a write request after conducting a reassignment process on the disk device group 104 in order to avoid an area in which a media error has occurred when a write request is to be issued to the storage area in which the media error has occurred.

Additionally, “a media error” in the present embodiment is an inevitable state such that a reading/writing process in a particular storage area can not be conducted due to a fault or the like in disk devices constituting the disk device group 104. Accordingly, in this state, when data is written to a storage area with a media error, data can not be read correctly even if the written data can be read.

The disk array control device 100 is connected to the disk device group 104 in such a way that they can communicate to each other and they constitute a disk array device (RAID). Additionally, a disk array device in the scope of the present invention is a disk array device with a disk device group 104 which is not in a redundant state (i.e. is in a state that lacks redundancy).

The phrase “the disk device group 104 which is in a redundant state” indicates, for example, a state such that the disk device group 104 employs a configuration in accordance with RAID1 or RAID5, and there is no disk device with a fault. Accordingly, the phrase “the disk device group 104 is not in a redundant state” indicates a state such that the disk device group 104 does not employ a redundant configuration such as RAID1 or RAID5, or a state such that the disk device group 104 effectively does not employ a redundant configuration due to a failure of a disk device or the like.

The disk array control device 100 is connected to an information processing device 105 in such a way that they can communicate to each other, and issue read/write requests to the disk devices group 104 in accordance with instructions from the information process device 105.

The media error information storage process unit 101 issues a read request to the disk device group 104 in order to conduct a process of reading data from the disk device group 104 and writing the read data in a cache memory (not shown) included in the disk array control device 100 (hereinafter referred to as “staging”).

Then, when the media error information storage process unit 101 detects a media error based on a response made by the disk device group 104 against the above request, and registers, in the media error management table 102, the storage area in which the media error has occurred in the disk devices group 104.

The media error management table 102 is a table in which storage areas in which media errors have occurred in the disk device group 104 are registered.

The media error avoidance process unit 103 issues a write request to the disk device group 104 in order to conduct a write-back process or the like in which data in cache memory is reflected to the disk device group 104 (synchronization) (hereinafter, simply referred to as “write-back process”) for example.

Then, the media error avoidance process unit 103 refers to the media error management table 102 and checks whether or not a storage area in which the data is to be written to the disk device group 104 (hereinafter, this storage area is referred to as “a specified storage area”) is registered in the media error management table 102.

When the specified storage area is registered in the media error management table 102, a reassignment request is issued to the disk device group 104. When the specified storage area in the disk device group 104 is assigned to another storage area (when a reassignment process is completed), a write request is issued and a write process of data in the disk device group 104 is conducted.

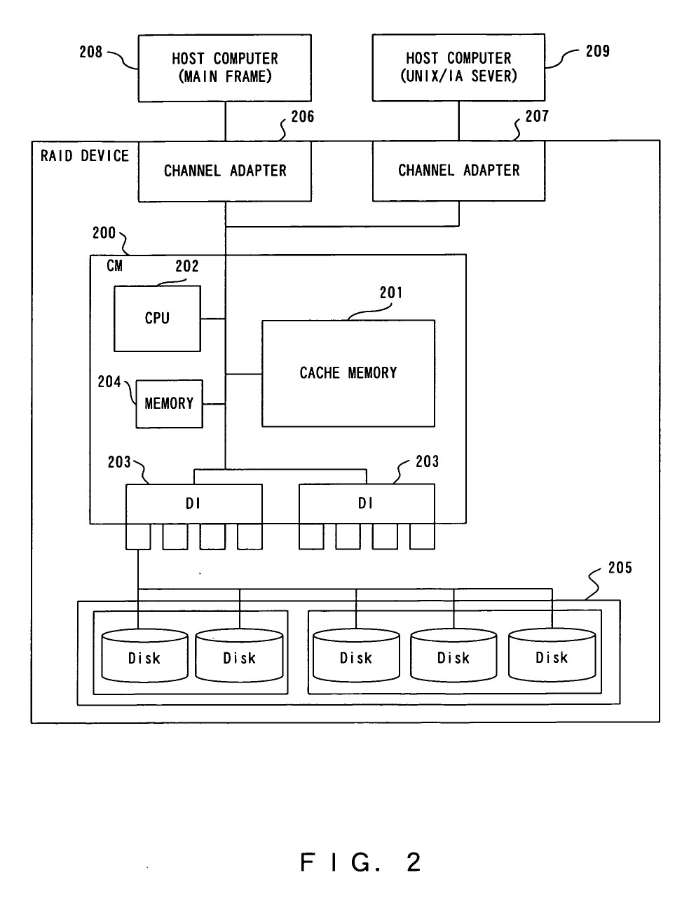

FIG. 2 explains a configuration of the disk array control device 100 of the present embodiment. A CM (controller module) 200 shown in FIG. 2 comprises, at least cache memory 201 for temporarily storing data, a CPU 202 for managing data in the cache memory 201 and for issuing read/write requests to a disk device group 205 as necessary, a DI (disk interface) 203 which is an interface to the disk devices group 205 and memory 204 for storing data such as the media error management table 102 or the like used by the CPU 202.

The CM 200 is connected to the disk device group 205 comprising a plurality of disk devices via the DI 203 in a such way that the CM 200 and the disk device group 205 can communicate with each other, and further is connected to host computers 208 and 209 via channel adapters 206 and 207 in such a way that the CM 200 and the host computers 208 and 209 can communicate with each other.

In the above configuration, the CPU 202 controls the respective components in the CM 200 and manages data in the cache memory 201. For example, when data requested by the host computer 208 is in the cache memory 201, the CPU transmits that data to the host computer 208 in response to the host computer's request. When the requested data is not in the cache memory 201, the CPU reads the data from the disk device group 205 and writes the data to the cache memory 201 by the staging process, and transmits the data to the host computer 208.

When the CPU 202 fails in reading the data from the disk device group 205 while conducting the above process, the CPU 202 determines the types of errors based on error information transmitted from the disk device group 205. When a media error is detected among the errors, the CPU 202 registers, in the media error management table 102 stored in the memory 204, the storage area in which the media error occurred in the disk device group 205.

Also, the CPU 202 stores data in the cache memory 201 in accordance with a write request from the host computer 208. Then, the CPU 202 conducts a write-back process in which data in the cache memory 201 is written to the disk device group 205 as necessary.

Then, the CPU 202 refers to the media error management table 102 prior to a write process of data in the disk device group 205, and confirms whether or not the specified storage area in the disk device group 205 in which the corresponding data is to be written is registered in the media error management table 102.

When the corresponding specified storage area is registered in the media error management table 102, the CPU 202 issues a reassignment request to the disk device group 205, and the specified storage area is reassigned to another storage area.

In the configuration explained above, the disk array device (RAID device) according to the present embodiment is a device which comprises at least the CM 200 and the disk device group 205 and which can be connected to the host computers 208 and 209 via the channel adapters 206 and 207 in such a way that the CM 200 and the host computers 208 and 209 can communicate with each other.

Additionally, in FIG. 2, the case in which two host computers 208 and 209 as information processing devices are connected to the RAID device is explained, naturally however, the present invention is not limited to this configuration. It is also possible to employ a configuration where the RAID device, has a duplicated CM 200, a triplicated CM 200 or the like.

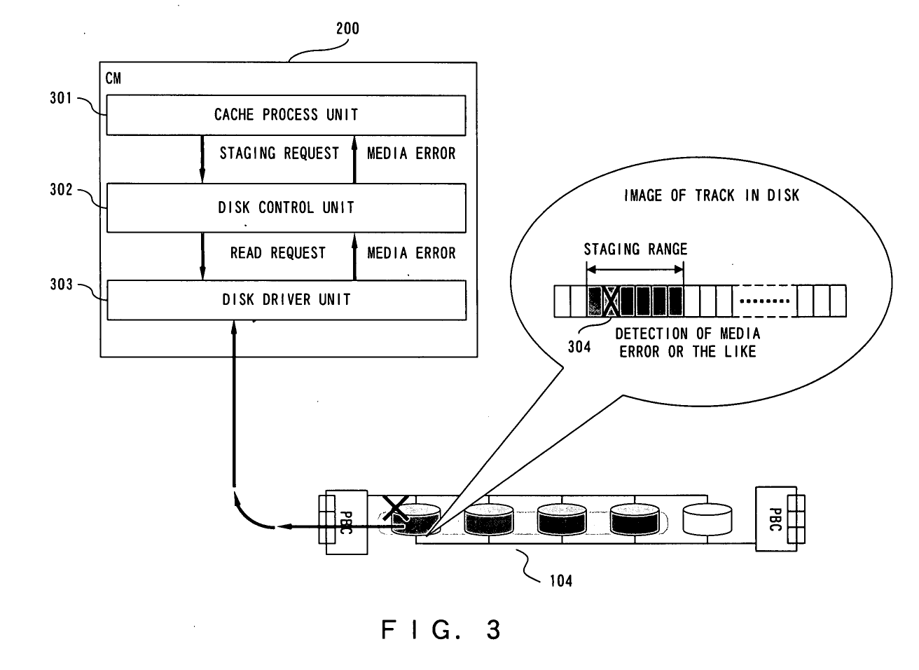

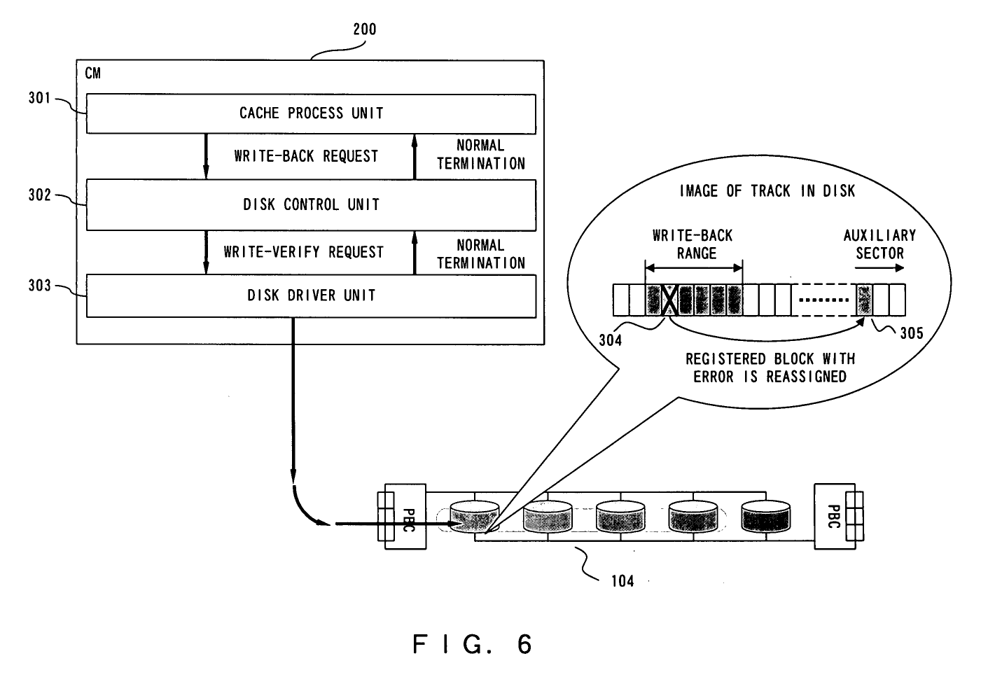

The media error information storage process unit 101 and the media error avoidance process unit 103 shown in FIG. 1 are realized by the instruction recorded in a prescribed program, which is executed by the CPU 202 provided in the CM 200. Accordingly, a media error information storage process conducted by the media error information storage process unit 101 is explained by referring to FIG. 3 to FIG. 5, and a media error avoidance process conducted by the media error avoidance process unit 103 is explained by referring to FIG. 6 to FIG. 8.

FIG. 3 explains the media error information storage process in accordance with the present invention.

The media error information storage process according to the present embodiment is realized by the instruction recorded in a prescribed program, which is executed by the CPU 202 provided in the CM 200. Accordingly, the media error information storage process unit comprises a cache process unit 301 for managing data in the cache memory 201, a disk control unit 302 for controlling the disk device group 104 and a disk driver unit 303 as an interface between the disk control unit 302 and the disk device group 104.

When the data requested by the host computer 208 is not stored in the cache memory 201 for example, the cache process unit 301 issues a staging request to the disk control unit 302.

When receiving the staging request from the cache process unit 301, the disk control unit 302 issues a read request to the disk device group 104, specifying the storage area in which the desired data is stored by a disc number of the disk device, an LBA (Logical Block Address) and a BC (Block Count). Hereinafter, the range of storage area specified by the disk number, the LBA, and the BC as above is referred to as a staging range.

When detecting a media error based on a response from the disk device group 104, the disk control unit 302 registers the LBA of the disk device in which the corresponding media error has occurred in the media error management table 102.

In the above, the disk devices group 104 comprises a plurality of disk devices, and reads the requested data from the disk device, and transmits the read data to the CM 200 in response to the read request from the CM 200 (the disk control unit 302). Also, the disk device group 104 stores the requested data in a prescribed storage area (the range specified by the disk number, the LBA and the BC) in the disk device group 104 in response to the write request from the CM 200 (the disk control unit 302).

Further, when there are one or more LBAs (storage areas) 304 that have become unreadable in a staging range, the disk device group 104 detects the media error as shown in FIG. 3. Then, the disk device group 104 transmits an error code or the like to the CM 200 in order to notify it of the occurrence of the corresponding media error. For example, the disk device group 104, when detecting a media error, transmits to the CM 200, the LBA 304 at which the media error has occurred and the disk number corresponding to the LBA together with the error code indicating an error.

Further, the disk device group 104 includes a function of conducting a reassignment process in which the LBA 304 at which the media error has occurred is assigned to another LBA in accordance with an instruction from the CM 200.

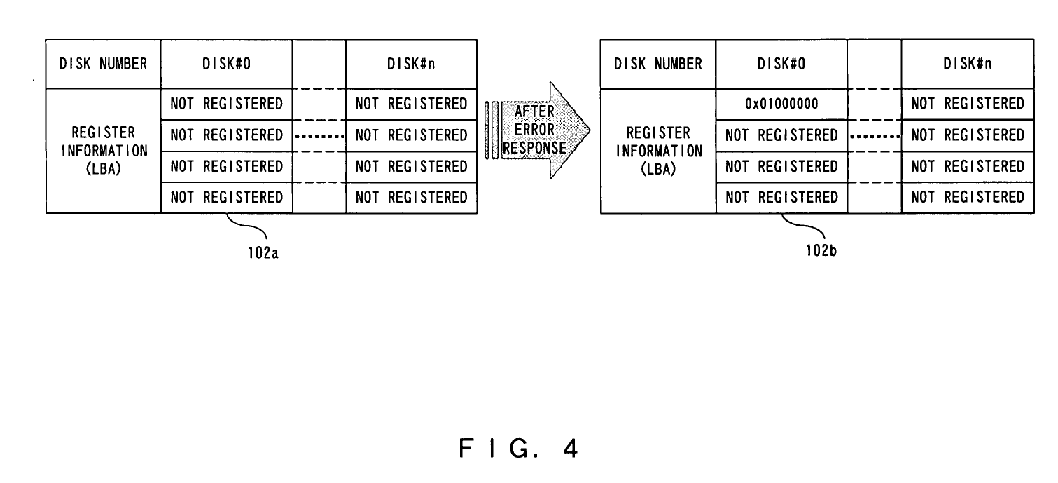

FIG. 4 shows an example of the media error management table 102 at the time of the media error information storage process according to the present embodiment.

A media error management table 102a shown in FIG. 4 shows the relationship between disk numbers (DISK#0 . . . DISK#n) and register information of disk devices in which a media error has occurred.

In the above, “the disk devices” indicates disk devices which constitute the disk device group 104. Additionally, as register information according to the present embodiment, the LBA at which a media error has occurred is used. Further, the media error management table 102a shown in FIG. 4 shows a state in which no information is registered because it reflects a state before detection of a media error.

A media error management table 102b shows a state in which the disk control unit 302 detecting a media error registered the LBA at which the corresponding media error occurred. The state indicates that a block with a disk number of DISK#0 and an LBA of 0x01000000 is registered in the media error management table 102b. Specifically, the state shows that a media error has occurred in a block with a disk number of DISK#0 and an LBA of 0x01000000.

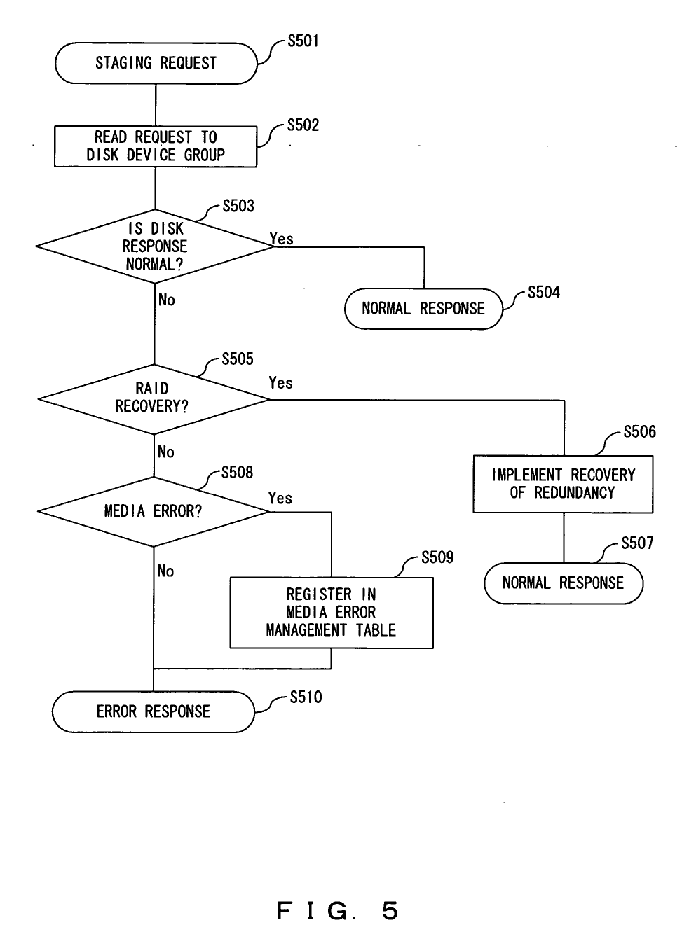

FIG. 5 is a flowchart for a process to register information in the media error management table 102 according to the present embodiment.

When the cache process unit 301 transmits a staging instruction and issues a staging request to the disk control unit 302 in a step S501, the disk control unit 302 issues a read request to the disk devices group 104 in a step S502.

When receiving the read request from the disk control unit 302, the disk device group 104 reads the requested data from a disk device, and when the data is read normally, transmits to the disk control unit 302 an end code that indicates that the read process completed normally together with the read data.

When the data is not read normally, an end code in accordance with the cause of the abnormal read (error code) is transmitted to the disk control unit 302.

In a step S503 when receiving an end code from the disk device group 104, the disk control unit 302 determines whether or not an error has occurred based on the response. Then, the disk control unit 302 conducts a process in a step S504 in order to issue a response indicating normality to the cache process unit 301 when the reading process is completed normally.

However, in the step S503 when the reading process is ended abnormally, the disk control unit 302 conducts a process in a step S505 to determine whether or not the error code indicates a RAID recovery error. Additionally, the “RAID recovery error” indicates a situation where a reading process is completed normally by repeating the process of the steps S503 to S505 several times.

In the step S505, the disk control unit 302 determines whether or not the error code indicates a RAID recovery error, and conducts a process in the step S506 when the error code indicates a RAID recovery error. When the disk device group 104 is in a redundant state, the disk control unit 302 conducts a recovery process. Then, the disk control unit 302 notifies the cache process unit 301 of a normal completion, and terminates the process (step S507).

The “recovery process” in the above is a process or the like in which when, for example, the disk device group 104 is configured in accordance with RAID1, data is read from a disk device which is a disk other than a disk in which the RAID recovery error has occurred and which is in a mirrored state with the disk with the above redundancy error. In the case of RAID5, however, the “recovery process” is a process or the like in which data which can not be read due to the RAID recovery error is restored by data and parity data that can be read.

In the step S505, when the error code does not indicate a RAID recovery error, the disk control unit 302 conducts a process in a step S508 and checks whether or not the error code indicates a media error. When, the error code indicates a media error, the disk control unit 302 conducts a process in a step S509, and registers the LBA of the disk device in which the media error occurred in the media error management table 102.

In a step S510, the disk control unit 302 issues an error response to the cache process unit 301 and terminates the process of registration in the media error management table 102.

The media error information storage process above is explained regarding the case in which the cache process unit 301 issues a staging request. However, the present invention is not limited to this case. For example, even when the cache process unit 301 issues a rebuild request to the disk control unit 302, the same processes are conducted as those in the steps S502 to S510 (except for the steps S505 to S507) because the disk control unit 302 issues a read request to the disk devices group 104.

Also, it is possible that the cache process unit 301 or the disk control unit 302 is provided with a disk patrol function, and that the disk control unit 302 issues a request to read prescribed data to the disk device group 104 for each predetermined period so that the processes in the steps S502 to S510 (except for the steps S505 to S507) are conducted.

FIG. 6 explains the media error avoidance process according to the present embodiment.

The media error avoidance process is realized by the instruction recorded in a prescribed program, which is executed by the CPU 202 provided in the CM 200, similarly to the media error information storage process shown in FIG. 3. Accordingly, the media error avoidance process unit 103 comprises the cache process unit 301 for managing data in the cache memory 201, the disk control unit 302 for controlling the disk device group 104 and the disk driver unit 303 as an interface between the disk control unit 302 and the disk device group 104.

The cache process unit 301 issues a write-back request to the disk control unit 302 at an arbitrary timing in order to cause data in the cache memory 201 and data in the disk devices group 104 to be synchronized with each other for example.

In the above process, the cache process unit 301 specifies the storage area by a disk number and a LBA in the disk control unit 302. Also, the cache process unit 301 specifies the amount of data to be written by the write-back process by the number of blocks BC.

When receiving the write-back request from the cache process unit 301, the disk control unit 302 refers to the media error management table 102, and then, checks whether or not the LBA of the disk number received together with the write-back request is registered.

When the corresponding LBA is registered in the media error management table 102, a reassignment request regarding the corresponding LBA is made to the disk control unit 302. When the reassignment process is completed, the disk control unit 302 issues a write verify request to the disk device group 104 by which data is written, and the data is verified in order to write the data of which the write-back request was made to the disk control unit 302.

The disk device group 104, when receiving the reassignment request from the disk control unit 302, reassigns the LBA 304 which is in an unreadable state to another LBA 305 as shown in FIG. 6.

Also, when receiving the write verify request from the disk control unit 302, the disk device group 104 writes data (data to be written) transmitted together with the request to a disk device, and then, reads the actual written data, compares the read data with the actual written data to be written in order to verify whether or not the data is written normally.

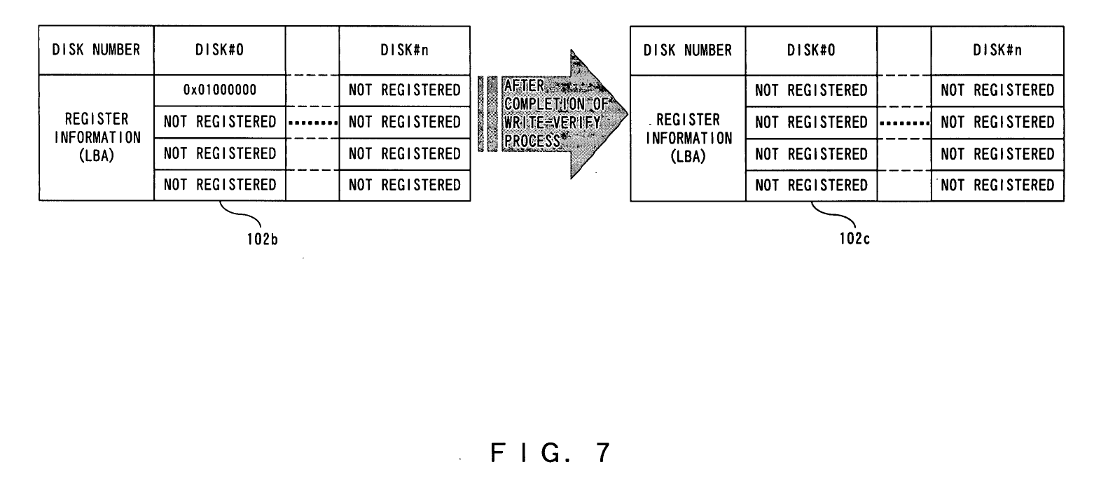

FIG. 7 shows an example of the media error management table 102 for the media error avoidance process according to the present embodiment.

The media error management table 102b shown in FIG. 7 is the same as that shown in FIG. 4. Specifically, the media error management table 102b includes disk numbers (DISK#0 . . . DISK#n) of disk devices in which a media error has occurred and register information of the disk in which a media error has occurred, and a block with a disk number of DISK#0 and a LBA of 0x01000000 is registered in it.

The media error management table 102c is the media error management table 102 after the write-back process is completed. The block with a disk number of DISK#0 and a LBA of 0x01000000 which had been registered is deleted because it is reassigned and the writing process regarding the block is completed normally.

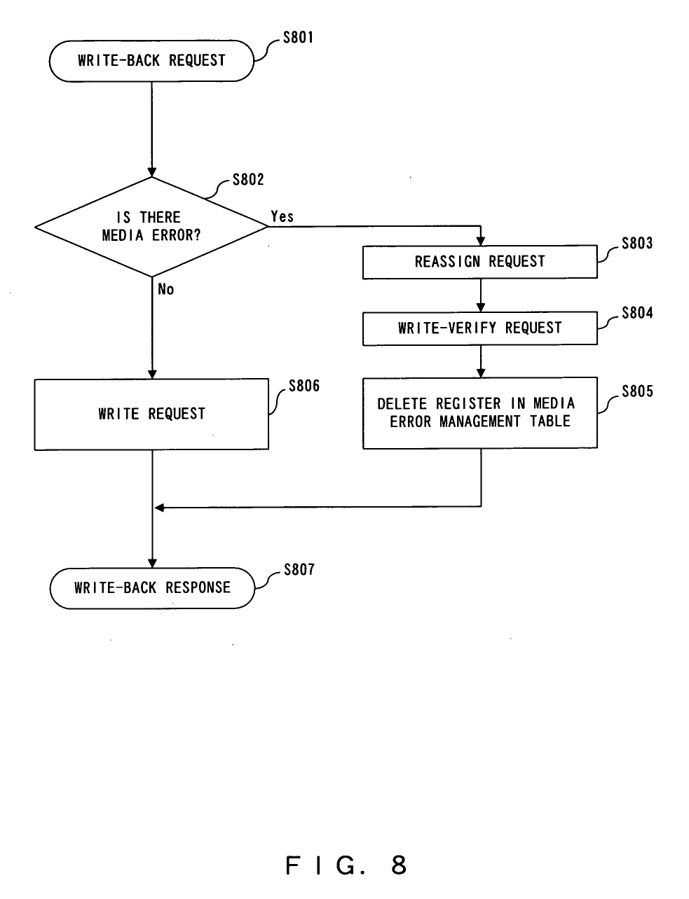

FIG. 8 is a flowchart for the media error avoidance process according to the present embodiment.

In a step S801, the cache process unit 301 transmits a write-back instruction to the disk control unit 302 and issues a write-back request.

In the above process, the cache process unit 301 transmits a disk number, an LBA and a BC together with data (or a data address in the cache memory 201) to the disk control unit 302, to specify the storage area.

In a step S802, when receiving the write-back request from the cache process unit 301, the disk control unit 302 refers to the media error management table 102 in the memory 204, and then, checks whether or not the LBA (the LBA in the specified storage area) of the disk number received from the cache process unit 301 is registered in the media error management table 102.

When the corresponding LBA is registered in the media error management table 102, the disk control unit 302 conducts a process in a step S803, and issues a reassignment request to the disk device group 104 regarding the corresponding LBA. When the reassign process in the disk device group 104 is completed, the disk control unit 302 conducts a process in a step S804. Then, the disk control unit 302 issues a write verify request to the disk device group 104, and the write-back process is conducted on a write-back range specified by the cache process unit 301.

When the write-back request is completed, the disk control unit 302 deletes (erases) a registered entry of the LBA which has been reassigned in the step S803 in the media error management table 102, and conducts a process in a step S807.

Also, in the step S802 when the LBA received from the cache process unit 301 is not registered in the media error management table 102, the disk control unit 302 conducts a process in a step S806, and issues a write request to the disk device group 104.

Then, in a step S807, the disk control unit 302 notifies the cache process unit 301 of a normal completion, and terminates the process.

As explained above, even in the case where an inevitable fault occurs in the disk device group 104 when the disk device group 104 is not in a redundant state, if a media error occurs in the disk devices group 104, the storage area in which the media error has occurred is registered in the media error management table 102 (S508 to S509) and a write verify process is conducted (S802 to S804) after a reassignment process, when a writing process is to be conducted to the storage area in which the corresponding error has occurred, accordingly, a recovery process can be easily conducted.

Also, the write verify process is conducted instead of a conventional write process after the reassign process, accordingly, reliability of the data written in the disk device group 104 can be improved.

What is claimed is:

1. A disk array control device, comprising:
a media error information storage process unit for detecting a media error which occurs in a disk device group based on a response to a read request issued to the disk device group including a combination of a plurality of disk devices, and for storing a storage area in which the media error occurred in a media error management table; and
a media error avoidance process unit for causing, when a write request to the storage area stored in the media error management table is to be issued, the disk device group to conduct a reassignment process of assigning the storage area to another storage area, and thereafter, issuing the write request.

2. The disk array control device according to claim 1, wherein:
a media error information storage process unit comprises:
a read request process unit for requesting, from the disk device group, data stored in a prescribed storage area in the disk device group;
a media error detection process unit for detecting, based on a response by the disk device made to the read request process unit, an occurrence of a media error upon reading the requested data; and
a management table registration process unit for registering a storage area in which the media error detected by the media error detection process unit occurred in the media error management table.

3. The disk array control device according to claim 1, wherein:
the media error avoidance process unit comprises:
a reassignment request process unit for determining whether or not a prescribed storage area is registered in the media error management table by referring to the media error management table, and for requesting, when the prescribed storage area is registered, the disk device group to conduct a reassignment process of assigning the prescribed storage area which is registered to another storage area prior to issuing a write request to the prescribed storage area in the disk device group; and
a write request process unit for requesting the disk device group to write data to the another storage area.

4. A recording medium for a program for recovering from a media error occurring in a disk device group for causing a disk array control device to conduct:
a media error information storage process of detecting a media error which occurs in a disk device group based on a response to a read request issued to the disk device group including a combination of a plurality of disk devices, and storing a storage area in which the media error occurred in a media error management table; and
a media error avoidance process of causing, when a write request to the storage area stored in the media error management table is to be issued, the disk device group to conduct a reassignment process of assigning the storage area to another storage area, and thereafter, issuing the write request.

5. The recording medium for a program for recovering from a media error occurring in a disk device group, according to claim 4, wherein:
the media error information storage process causes a disk array control device to conduct:
a read request process of requesting, from the disk device group, data stored in a prescribed storage area in the disk device group;
a media error detection process of detecting, based on a response by the disk device made to the read request process, an occurrence of a media error upon reading the requested data; and
a management table registration process of registering a storage area in which the media error detected by the media error detection process occurred in the media error management table.

6. The recording medium for a program for recovering from a media error occurring in a disk device group, according to claim 4, wherein:
the media error avoidance process causes a disk array control device to conduct:
a reassign request process of determining whether or not a prescribed storage area is registered in the media error management table by referring to the media error management table, and requesting, when the prescribed storage area is registered, the disk device group to conduct a reassignment process of assigning the prescribed storage area which is registered to another storage area prior to issuing a write request to the prescribed storage area in the disk device group; and
a write request process of requesting the disk device group to write data in the another storage area.

7. A disk array device, comprising:
a disk device group including a combination of a plurality of disk devices, which has a function of conducting a reassignment process of assigning a storage area with a fault to another area;
a media error information storage process unit for detecting a media error which occurred in a disk device group based on a response to a read request made to the disk device group, and for storing a storage area in which the media error occurred in a media error management table; and
a media error avoidance process unit for causing, when a write request to the storage area stored in the media error management table is to be issued, the disk device group to conduct a reassignment process of the storage area, and thereafter, issue the write request.

8. The disk array device, according to claim 7, wherein:
the media error information storage process unit comprises:
a read request process unit for requesting, from the disk device group, data stored in a prescribed storage area in the disk device group;
a media error detection process unit for detecting, based on a response by the disk device made to the read request process unit, an occurrence of a media error upon reading the requested data; and
a management table registration process unit for registering a storage area in which the media error detected by the media error detection process unit occurred in the media error management table.

9. The disk array device, according to claim 7, wherein:
the media error avoidance process unit comprises:
a reassignment request process unit for determining whether or not a prescribed storage area is registered in the media error management table by referring to the media error management table, and for requesting, when the prescribed storage area is registered, the disk device group to conduct a reassignment process of assigning the prescribed storage area which is registered to another storage area prior to issuing a write request to the prescribed storage area in the disk device group; and
a write request process unit for requesting the disk device group to write data to the another storage area.
